(19) United States
(12) Patent Application Publication
(10) Pub. No.: US 2015/0271457 A1
(43) Pub. Date: Sep. 24, 2015

(54) DISPLAY DEVICE, IMAGE DISPLAY SYSTEM, AND INFORMATION PROCESSING METHOD

(71) Applicant: KABUSHIKI KAISHA TOSHIBA, Tokyo (JP)

(72) Inventors: Yoshiyuki KOKOJIMA, Yokohama (JP); Shimpei SAWADA, Kawasaki (JP); Wataru WATANABE, Kawasaki (JP); Masahiro BABA, Yokohama (JP)

(21) Appl. No.: 14/659,941

(22) Filed: Mar. 17, 2015

(30) Foreign Application Priority Data
Mar. 18, 2014 (JP) 2014-055167

(51) Int. Cl. H04N 9/31; G06F 3/041

(52) U.S. Cl. CPC H04N 9/31; G06F 3/041

(57) ABSTRACT

According to an embodiment, a display device includes a projector to project light including information about a projection image; an optical member to transmit light from an information processing device but reflect the light including the information, the information processing device including a detector to detect touch operation onto a display screen and a display displaying a first image representing a display image; and a first obtainer to obtain the projection image formed by transforming a second image, which includes a non-overlapping area of the display image representing an area not overlapping with a part of the first image, based on position of the display such that, from light having come from the information processing device and having passed through the optical member and from the light including the information having reflected from the optical member, a state in which the non-overlapping area is present around the display is viewable.

### CROSS-REFERENCE TO RELATED APPLICATIONS

This application is based upon and claims the benefit of priority from Japanese Patent Application No. 2014-055167, filed on Mar. 18, 2014; the entire contents of which are incorporated herein by reference.

### FIELD

Embodiments described herein relate generally to a display device, an image display system, and an information processing method.

### BACKGROUND

In recent years, wearable devices such as wrist-watch type terminals or glasses-type terminals are receiving attention. Regarding a glasses-type terminal that is worn by a user in the head region and that is capable of projecting an image, which is displayed on a compact display thereof, onto an optical system in front of the user and thus presenting the projected image to the user; there are two broad types, namely, a video see-through type and a optical see-through type. A video see-through type terminal is suitable in displaying highly realistic pictures by covering the entire field of view of the wearer. Many of the conventionally known head-mounted displays (HMDs) are categorized as video see-through type terminals. On the other hand, optical see-through type terminals are suitable in displaying auxiliary information without blocking the field of view of the wearer, and are often more compact and lighter than video see-through type terminals.

Such wearable devices have excellent immediacy and portability characteristics. Therefore, the wearer can see information in a hands-free manner anytime and anywhere. However, because of the hands-free nature, there arises the issue of having difficulty in operating such wearable devices. In that regard, a technology has been put to practical use in which a wearable device is operated with voice commands, and a technology has been put to practical use in which a wearable device is operated by touching a touch-sensitive panel embedded in a temple of a glasses-type terminal. However, the use of such technologies gives an unnatural look and feel to the operations, thereby making it difficult to use a wearable device in public places.

In order to resolve such issues, a technology has been proposed in which a wearable device (typically, a glasses-type terminal) is operated using a portable terminal such as a cellular phone, a smartphone, or a tablet. For example, a conventional technology is known in which a camera embedded in a glasses-type terminal takes an image of the screen of a portable terminal. Then, an image of the outside area, which cannot be sufficiently displayed on the screen of the portable terminal, is synthesized in a manner of covering the periphery of the screen of the portable terminal appearing in the taken image; and the images are joined to constitute a single large screen that is displayed on the glasses-type terminal. In this technology, the user can touch the screen of the portable terminal, and can specify a specific position within the area of the large screen, which is presented by the glasses-type terminal, in which the screen of the portable terminal is displayed. Then, the image displayed on the glasses-type terminal can be controlled according to the touch operation performed by the user.

However, the conventional technology mentioned above is based on the premise that a video see-through type glasses-type terminal is used. Hence, the wearer cannot have the understanding of the surroundings with his or her own eyes. It is although possible to understand about the surroundings via the images taken by the camera embedded in the glasses-type terminal. However, considering the fact that the dead battery or malfunctioning results in the loss of visibility of the user, it is not practical to use the terminal outdoors from the safety perspective. Hence, in the conventional technology, the usage environment gets restricted thereby hampering the user-friendliness.

### BRIEF DESCRIPTION OF THE DRAWINGS

FIG. 1 is a block diagram illustrating an exemplary overall configuration of an image display system according to embodiments;

FIG. 2 is a diagram illustrating an exemplary functional configuration of the image display system according to a first embodiment;

FIG. 3A is a diagram illustrating an example of a display image;

FIG. 3B is a diagram illustrating an example of a first image;

FIG. 3C is a diagram illustrating an example of a second image;

FIG. 4 is a diagram illustrating an example of positioning of each constituent element of a glasses-type terminal according to the first embodiment;

FIGS. 5A, 5B and 5C are diagrams for explaining a detection method implemented by a detector according to the first embodiment;

FIGS. 6A, 6B and 6C are diagrams illustrating reflected images of an outside area that is viewable through an optical member according to the first embodiment;

FIG. 7 is a diagram illustrating an exemplary hardware configuration of a portable terminal according to the first embodiment;

FIG. 8 is a flowchart for explaining an example of operations performed in the portable terminal according to the first embodiment;

FIG. 9 is a flowchart for explaining an example of operations performed in the glasses-type terminal according to the first embodiment;

FIG. 10 is a diagram illustrating exemplary functional configuration of the image display system according to a modification example of the first embodiment;

FIG. 11 is a diagram illustrating exemplary functional configuration of the image display system according to a modification example of the first embodiment;

FIG. 12 is a diagram illustrating exemplary functional configuration of the image display system according to a modification example of the first embodiment;

FIG. 13 is a diagram illustrating exemplary functional configuration of the image display system according to a modification example of the first embodiment;

FIG. 14 is a diagram illustrating exemplary functional configuration of the image display system according to a modification example of the first embodiment;

FIG. 15 is a diagram illustrating an exemplary functional configuration of the image display system according to a second embodiment;

FIG. 16 is a diagram illustrating an exemplary functional configuration of the image display system according to a modification example of the second embodiment;

FIG. 17 is a diagram illustrating an exemplary functional configuration of the image display system according to a third embodiment;

FIG. 18 is a diagram illustrating an example of a hemming area according to the third embodiment;

FIG. 19 is a diagram illustrating an exemplary functional configuration of the image display system according to a modification example of the third embodiment;

FIG. 20 is a diagram illustrating an exemplary functional configuration of the image display system according to a fourth embodiment;

FIG. 21 is a diagram illustrating an exemplary functional configuration of the image display system according to a modification example of the fourth embodiment;

FIG. 22 is a diagram illustrating an exemplary functional configuration of the image display system according to a fifth embodiment; and

FIG. 23 is a diagram illustrating an exemplary functional configuration of the image display system according to a modification example of the fifth embodiment.

### DETAILED DESCRIPTION

According to an embodiment, a display device includes a projector, an optical member, and a first obtainer. The projector projects light including information about a projection image. The optical member transmits light coming from an information processing device but reflect the light including the information about the projection image incident thereon. The information processing device includes a first detector capable of detecting a touch operation onto a display screen and a display that displays a first image representing at least a part of a display image. The first obtainer obtains the projection image formed by performing transformation on a second image, which includes a non-overlapping area of the display image representing an area not overlapping with at least a part of the first image, based on position of the display in such a way that, from light that has come from the information processing device and has passed through the optical member and from the light including the information about the projection image that has reflected from the optical member, a state in which the non-overlapping area is present around the display is viewable.

Various embodiments will be described below in detail with reference to the accompanying drawings.

### First Embodiment

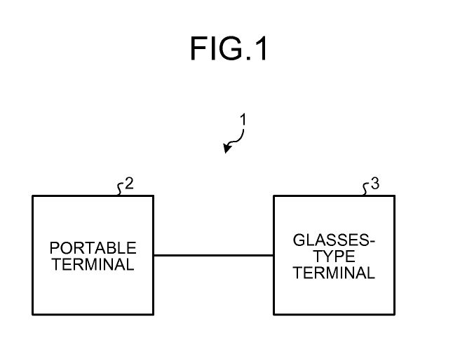

FIG. 1 is a block diagram illustrating an exemplary overall configuration of an image display system 1 according to the embodiments. As illustrated in FIG. 1, the image display system 1 includes a portable terminal 2 and a glasses-type terminal 3. The portable terminal 2 and the glasses-type terminal 3 can communicate with each other directly or indirectly via a wired connection or a wireless connection. Regarding the method of communication between the portable terminal 2 and the glasses-type terminal 3; any arbitrary method of communication can be implemented.

The portable terminal 2 at least includes a touch-sensitive panel 4 (described later) used to perform touch operations. The portable terminal 2 is configurable with a mobile device, such as a smartphone or a tablet, or with a wearable device, such as a wrist-watch type terminal or a necklace-type terminal, that can be carried along by the user. In this example, the portable terminal 2 can be considered to be corresponding to an “information processing device” mentioned in claims.

The glasses-type terminal 3 is a display device that is worn by a user in the head region; and that is capable of projecting an image, which is displayed on a compact display thereof, onto an optical system in front of the user and thus presenting the projected image to the user. The glasses-type terminal 3 is broadly divided into two types, namely, a video see-through type and an optical see-through type. However, herein, the explanation is limited to an optical see-through-type terminal. Although an optical see-through type terminal is often compact in size, it may also be of a large size. Besides, the glasses-type terminal 3 can be of a monocular type in which information is displayed only to one eye, or can be of a binocular type in which information is displayed to both eyes. Herein, any one of those two types may be used. In this example, the glasses-type terminal 3 can be considered to be corresponding to a “display device” mentioned in claims.

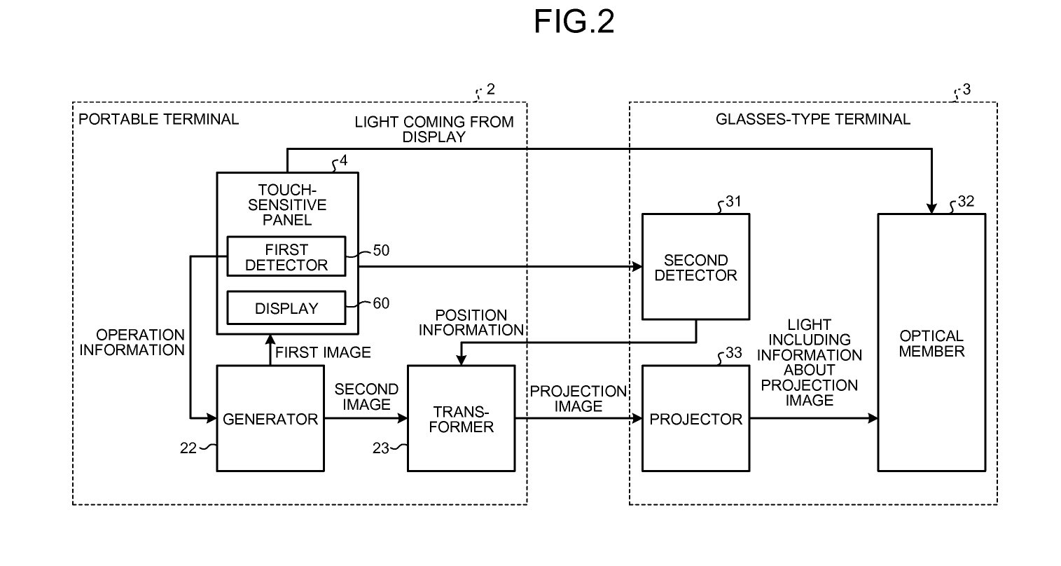

FIG. 2 is a diagram illustrating an exemplary functional configuration of the portable terminal 2 and the glasses-type terminal 3. As illustrated in FIG. 2, the portable terminal 2 includes the touch-sensitive panel 4, a generator 22, and a transformer 23.

The touch-sensitive panel 4 includes a first detector 50 and a display 60. The first detector 50 is capable of detecting a touch operation performed onto a display surface (the surface of the touch-sensitive panel 4 (the display 60) on which images are displayed). In this example, the first detector 50 corresponds to a “first detector” and a “detector” mentioned in claims. In response to the touch operation detected by the first detector 50, the display 60 displays a first image, which is at least a part of a display image. The display 60 can be of any arbitrary type. For example, the display 60 can be a direct-view-type display device such as a liquid crystal display device or an organic electroluminescence (EL) display device; or can be a projection-type display device such as a projector. Moreover, the method for detecting a touch operation can be any arbitrary method. That is, the detection method is not limited to the capacitance method or the resistance touch method (the pressure-sensitive method). Thus, a detecting device implementing some other detection method can also be used. When a touch operation performed by the user is detected, the touch-sensitive panel 4 (the first detector 50) sends, to the generator 22, operation information indicating the detected touch operation.

Meanwhile, a “touch operation” mentioned in the description not only indicates an operation in which the user touches a finger to the display surface but can also indicate an operation in which the user touches a pen or an input device to the display surface.

Based on the operation information received from the first detector 50 and based on a display image that is provided in advance, the generator 22 generates a first image and generates a second image that includes a non-overlapping area of the display image representing an area not overlapping with at least a part of the first image. In the first embodiment, the non-overlapping area represents an area of the display image on the outside of the first image (i.e., represents an area of the display image other than the first image; in the following explanation, sometimes referred to as an “outside area”). Moreover, the generator 22 sends the first image to the touch-sensitive panel 4 (the display 60). Then, the display 60 displays the first image generated by the generator 22.

Meanwhile, in this example, the explanation is given under the assumption that the display image is of a size that cannot be sufficiently displayed in the display 60. Herein, the generator 22 can obtain the display image according to any arbitrary method. For example, the generator 22 can obtain the display image from an external device such as a server device, or can obtain the display image by accessing a memory (not illustrated) in which the display image is stored in advance.

For example, if a touch operation detected by the first detector 50 indicates scrolling of the display image from side to side and up and down with the aim of displaying, in the display 60, the portion that is not being sufficiently displayed in the display 60; then the generator 22 scrolls the display image according to the operation information and generates an image (a first image) that should be displayed in the display 60. Alternatively, for example, if a touch operation detected by the first detector 50 indicates enlarging/reducing the image that is currently being displayed in the display 60; then the generator 22 enlarges or reduces the image, which is currently being displayed in the display 60, according to the detected touch operation and generates an image (a first image) that should be displayed in the display 60. Still alternatively, for example, if a touch operation detected by the first detector 50 indicates selecting a URL link (URL stands for Uniform Resource Locator) for jumping to a webpage in which predetermined information is viewable, then the generator 22 generates the image of the destination webpage as an image (a first image) that should be displayed in the display 60.

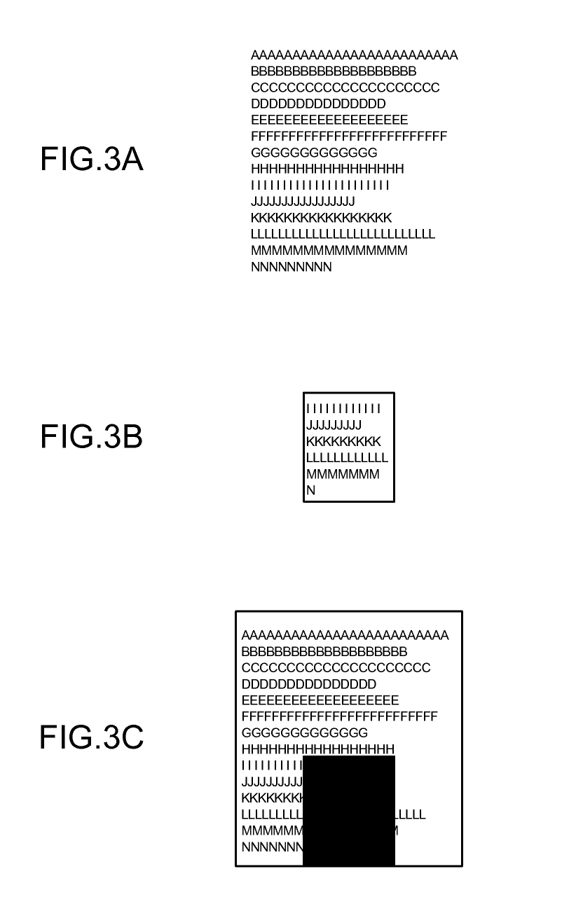

In the following explanation, as an example, it is assumed that a display (content) image is provided that includes a text as illustrated in FIG. 3A. The generator 22 generates an image illustrated in FIG. 3B as the first image. Moreover, the generator 22 generates the second image illustrated in FIG. 3C that includes the area on the outside of the first image in the display image (i.e., the area that was not sufficiently displayed in the display 60; equivalent to the non-overlapping area). In this example, in the second image, the area of the display image corresponding to the first image is set to have the luminance value (the pixel value) equal to or smaller than a predetermined threshold value (in this example, the luminance value equivalent to “black”).

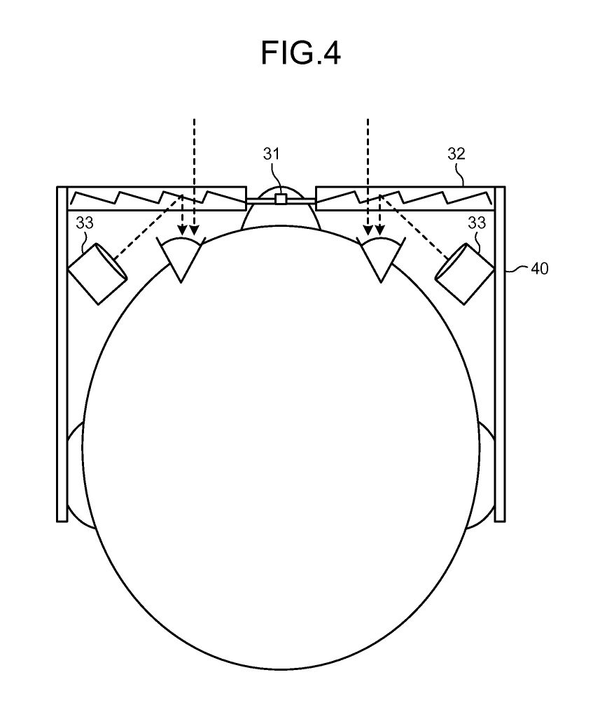

Prior to explaining about the transformer 23 of the portable terminal 2, the explanation is given about a configuration of the glasses-type terminal 3. As illustrated in FIG. 2, the glasses-type terminal 3 includes a second detector 31, an optical member 32, and a projector 33. FIG. 4 is a schematic diagram illustrating an example of positioning of each constituent element of the glasses-type terminal 3. As illustrated in FIG. 4, the glasses-type terminal 3 further includes a holding member 40 that holds the second detector 31, the optical member 32, and the projector 33.

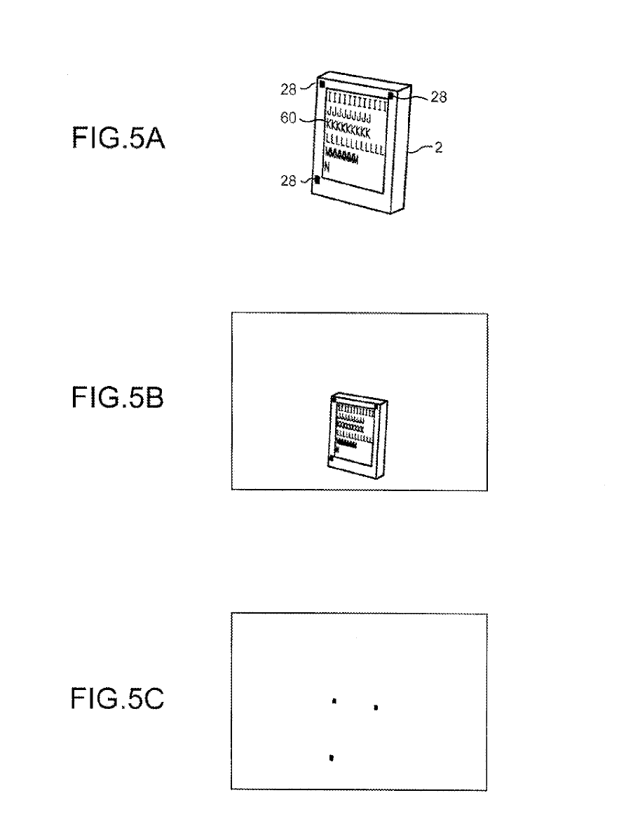

The second detector 31 detects the position of the portable terminal 2 (the display 60). In the first embodiment, the second detector 31 is configured with an infrared camera. Moreover, the second detector 31 is oriented in the same direction as the line of sight of the user, and can capture almost the same range as the field of view of the user. Meanwhile, in the first embodiment, as illustrated in FIG. 5A, around the display 60 (the touch-sensitive panel 4) are disposed at least three infrared LED markers 28 that emit infrared light having a longer wavelength than the visible light. When the display 60 is present within the field of view of the user, the second detector 31 can take an image that captures the infrared LED markers 28 disposed around the display 60.

For example, as illustrated in FIG. 5B, when the portable terminal 2 is present within the field of view of the user, the second detector 31 can take an image that captures the positioning of the three infrared LED markers 28 as illustrated in FIG. 5C. For example, if the blinking patterns of the three infrared LED markers 28 are varied or if the frequencies of the light are varied, then it becomes possible to identify (detect) the positions in the image illustrated in FIG. 5C at which the three infrared LED markers 28 appear. The second detector 31 generates position information, which indicates the positions of the three infrared LED markers 28 (in this example, the coordinate values in the image), and sends the position information to the portable terminal 2.

Continuing with the explanation about the configuration of the glasses-type terminal 3, the projector 33 illustrated in FIGS. 2 and 4 obtains an projection image from the transformer 23 of the portable terminal 2, and projects a light including the information about the projection image onto the optical member 32 disposed in front of the user. The specific details of the projection image are given later. The projector 33 includes a display device (not illustrated) for displaying the projection image and an optical system (not illustrated) such as a lens for guiding the light coming from the display device toward the optical member 32. Herein, the display device for displaying the projection image can be of any arbitrary type. For example, the display device can be a liquid crystal transmission-type display device or an organic EL display device. However, that is not the only possible case. Alternatively, the projector 33 can be configured with a digital micromirror device (DMD) panel.

Meanwhile, as illustrated in FIG. 4, the optical member 32 transmits light coming from the outside world, which is on the opposite side of the eyes of the user across the optical member 32; while reflects the incident light including the information about the projection image (that is projected by the projector 33). The specific details of the projection image are given later. When the portable terminal 2 is present within the field of view of the user who is wearing the glasses-type terminal 3, the optical member 32 transmits the light coming from the portable terminal 2 (i.e., the light that forms a real image of the portable terminal 2); while reflects the incident light including the information about the projection image. The light coming from the portable terminal 2 falls on a different face of the optical member 32 than the face on which the light including the information about the projection image falls. Then, the light that has come from the portable terminal 2 and has passed through the optical member 32 is guided to the eyes of the user; and the light that includes the information about the projection image and that has reflected from the optical member 32 is also guided to the eyes of the user. In this example, although the optical member 32 is configured with a half mirror, that is not the only possible case. Moreover, the transmittance of the optical member 32 (i.e., the percentage of transmission of the light coming from the outside world) as well as the reflectance of the optical mirror 32 (i.e., the percentage of reflection of the light of the projection image) is not limited to 50% and can be set in an arbitrary manner in accordance with the performance of the display 60 and the projector 33.

Returning to the explanation with reference to FIG. 2, the following explanation is given about the transformer 23 of the portable terminal 2. The transformer 23 generates a projection image by performing transformation on the second image based on the position of the display 60 in such a way that, from the light that has come from the portable terminal 2 and has passed through the optical member 32 and from the light that includes the information about the projection image and that has reflected from the optical member 32, it is possible to view the state in which the outside area (equivalent to the non-overlapping area of the display image representing an area not overlapping with at least a part of the first image) is present around the display 60. The transformation mentioned herein is geometric transformation including affine transformation. More particularly, the explanation is as given below.

In the first embodiment, the transformer 23 obtains the position information from the second detector 31 of the glasses-type terminal 3, and calculates the relative position and orientation of the display 60 with respect to the glasses-type terminal 3 from the obtained position information. However, that is not the only possible case. Alternatively, for example, from the position information indicating the positions of the three infrared LED markers 28, the second detector 31 of the glasses-type terminal 3 calculates the relative position and orientation of the display 60 with respect to the glasses-type terminal 3. Then, the second detector 31 sends the calculation result to the transformer 23.

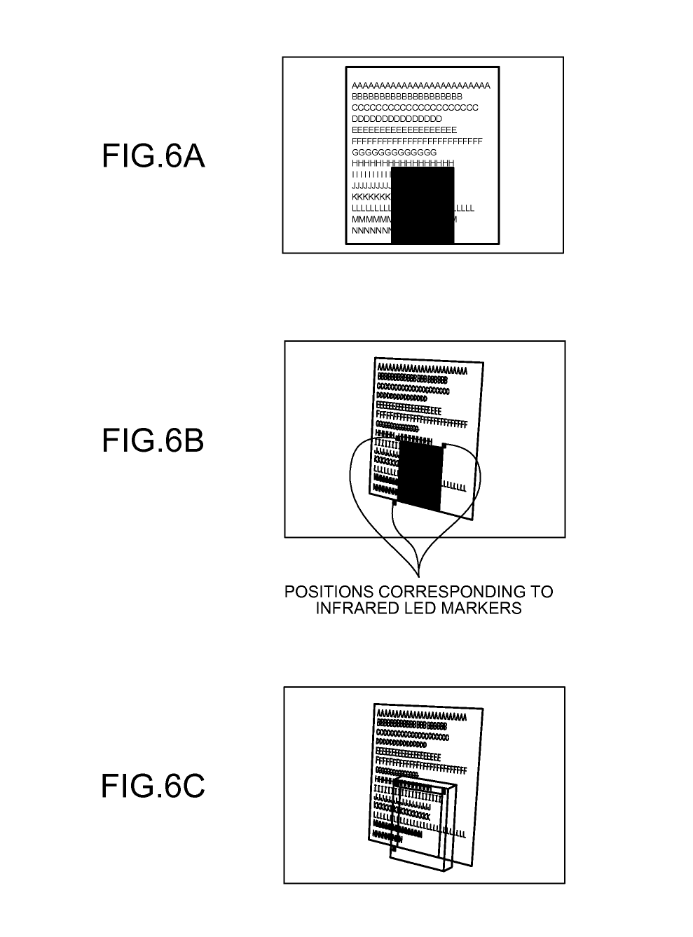

The relative position and orientation of the display 60 with respect to the glasses-type terminal 3 can be expressed as a transformation matrix for performing affine transformation in such a way that the reflected image of the outside area viewable through the optical member 32 is transformed from an initial state illustrated in FIG. 6A to fit the marker positions illustrated in FIG. 6B (the marker positions in the display 60 that is slightly tilted from the initial state). The transformation matrix can be calculated using, for example, existing software such as ARToolKit. Using the calculated transformation matrix, the transformer 23 performs affine transformation on the second image generated by the generator 22, and generates a projection image. Then, the transformer 23 sends the projection image to the glasses-type terminal 3.

The projector 33 of the glasses-type terminal 3 projects, onto the optical member 32, a light that includes information about the projection image generated in the manner described above. As a result, as illustrated in FIG. 6C, it becomes possible to demonstrate to the user that the transmission image of the display 60 viewable through the optical member 32 (in this example, the transmission image of the display 60 that is slightly tilted from the initial state) and the reflected image of the outside area viewed through the optical member 32 jointly constitute a single large screen.

Meanwhile, when the projector 33 projects the projection image corresponding to in FIG. 6B onto the optical member 32; there is no reflection of light from the area of the projection image that corresponds to the blacked-out area illustrated in FIG. 6B (the area representing the first image), and thus no reflected image is formed. Hence, in the blacked-out area illustrated in FIG. 6B, the user happens to view a transmission image formed due to the light that has come from the outside world and has passed through the optical member 32 (in this example, the transmission image of the display 60). On the other hand, reflection of light occurs from the area of the projection image that corresponds to the area on the outside of the blacked-out area illustrated in FIG. 6B, and thus a reflected image is formed. Hence, in the area on the outside of the blacked-out area illustrated in FIG. 6B, the user happens to view a reflected image formed due to the light that includes information about the projection image and that has reflected from the optical member 32. As a result, it appears to the user that the transmission image of the display 60 and the reflected image of the outside area of the display image which could not be sufficiently displayed in the display 60 jointly constitute a single large screen.

In this way, in the first embodiment, the projector 33 of the glasses-type terminal 3 has the function of obtaining the projection image generated by the transformer 23 and projecting the light including information about the obtained projection image onto the optical member 32. In this example, the projector 33 can be considered to have the function corresponding to a “first obtainer” mentioned in claims and the function corresponding to a “projector” mentioned in claims. However, that is not the only possible case. Alternatively, the configuration can be such that a constituent element having the function corresponding to the “first obtainer” mentioned in claims can be disposed separately from the projector 33.

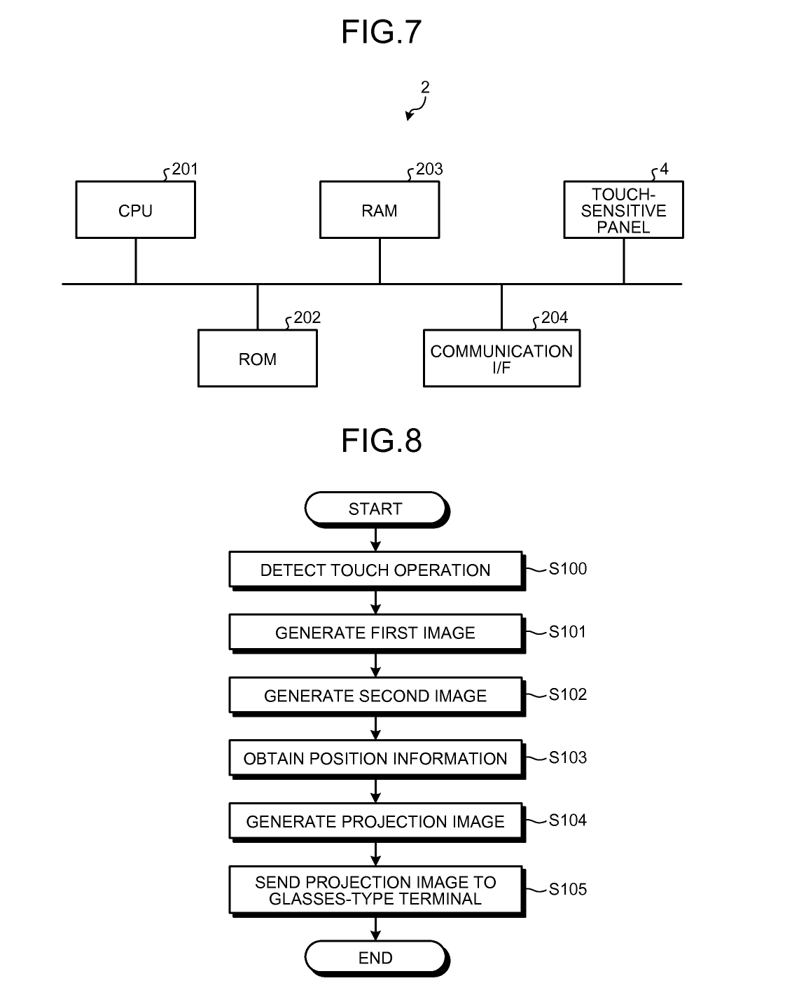

FIG. 7 is a diagram illustrating an exemplary hardware configuration of the portable terminal 2. As illustrated in FIG. 7, the portable terminal 2 includes a central processing unit (CPU) 201, a read only memory (ROM) 202, a random access memory (RAM) 203, a communication interface (I/F) 204 for communicating with the glasses-type terminal 3, and the touch-sensitive panel 4. When the CPU 201 reads computer programs stored in the ROM 202, loads the computer programs in the RAM 203, and executes them; the functions of the generator 22 and the transformer 23 of the portable terminal 2 are implemented. However, that is not the only possible case. Alternatively, for example, at least some of the functions of the generator 22 and the transformer 23 of the portable terminal 2 can be implemented using dedicated hardware circuitry (for example, a semiconductor integrated circuit).

The computer programs executed in the portable terminal 2 can be saved as downloadable files on a computer connected to a network such as the Internet or can be made available for distribution through a network such as the Internet. Alternatively, the computer programs executed in the portable terminal 2 can be stored in advance in a nonvolatile recording medium such as a ROM.

Given below is the explanation of an example of operations performed in the image display system 1 according to the first embodiment. Firstly, explained with reference to FIG. 8 is an example of operations performed in the portable terminal 2. As illustrated in FIG. 8, firstly, the first detector 50 detects a touch operation (Step S100). Then, the generator generates a first image according to the touch operation detected at Step S100 (Step S101). Subsequently, the generator 22 generates a second image according to the touch operation detected at Step S100 (Step S102). Then, the transformer 23 obtains the position information from the portable terminal 2 (Step S103). In the first embodiment, upon detecting a touch operation at Step S100, the touch-sensitive panel 4 requests the glasses-type terminal 3 (the second detector 31) to send the position information. Thus, at Step S103, the transformer 23 can obtain the position information from the glasses-type terminal 3 (the second detector 31) as a response to the request by the touch-sensitive panel 4. However, that is not the only possible case. Alternatively, for example, the configuration can be such that the second detector 31 of the glasses-type terminal 3 performs the detection after the elapse of a predetermined period of time; and, every time the second detector 31 performs the detection, the position information indicating the detection result at that point of time is sent to the portable terminal 2 and is sequentially stored in a memory (not illustrated). In such a configuration, at Step S103, the transformer 23 can obtain the latest position information from the memory (not illustrated).

Based on the position information obtained at Step S103, the transformer 23 performs affine transformation on the second image, which is generated at Step S102, and generates a projection image (Step S104). In this example, the transformer 23 generates a projection image by performing affine transformation on the second image, which is generated at Step S102, based on the position information, which is obtained at Step S103, in such a way that, from the light that has come from the portable terminal 2 and has passed through the optical member 32 and from the light that includes the information about the projection image and that has reflected from the optical member 32, it is possible to view the state in which the outside area is present around the display 60. Then, the transformer 23 sends the projection image, which is generated at Step S104, to the glasses-type terminal 3 (Step S105).

In this example, it is possible to think that the portable terminal 2 obtains the position of the display 60 as well as performs control to project, onto the glasses-type terminal 3, the projection image that is generated by performing transformation on the second image based on the position of the display 60 in such a way that, from the light that has come from the portable terminal 2 and has passed through the optical member 32 and from the light that includes the information about the projection image and that has reflected from the optical member 32, it is possible to view the state in which the outside area is present around the display 60.

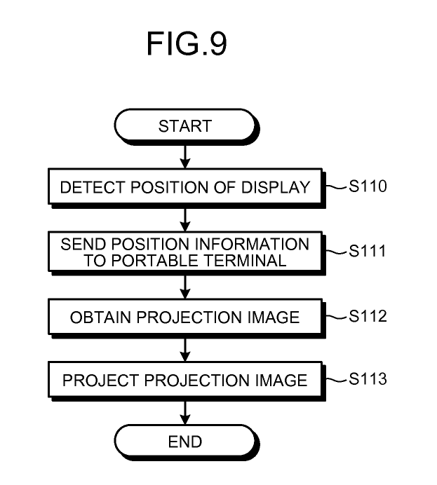

Explained below with reference to FIG. 9 is an example of operations performed in the glasses-type terminal 3. In this example, the explanation is given for an example of operations performed in the glasses-type terminal 3 after the portable terminal 2 has issued a request to send position information. Firstly, the second detector 31 detects the position of the display 60 (Step S110). As described above, the second detector 31 captures almost the same range as the field of view of the user and detects the positions at which the three infrared LED markers 28, which are disposed around the display 60, appear in the image. Then, the second detector 31 sends position information, which indicates the detection result obtained at Step S110, to the portable terminal 2 (Step S111). Subsequently, the projector 33 obtains the projection image generated by the portable terminal 2 (Step S112). Then, the projector 33 projects, onto the optical member 32, a light that includes information about the projection image obtained at Step S112 (Step S113).

As described above, the glasses-type terminal 3 according to the first embodiment is configured as an optical see-through type terminal in which the light coming from the portable terminal 2 is guided by the optical member 32 to the eyes of the user, and the light including the information about the projection image is reflected from the optical member 32 toward the eyes of the user. Then, the projector 33 of the glasses-type terminal 3 obtains a projection image that is generated by performing transformation on the second image, which includes the area of the display image on the outside of the first image, based on the position of the display 60 in such a way that, from the light that has come from the portable terminal 2 and has passed through the optical member 32 and from the light that includes the information about the projection image and that has reflected from the optical member 32, it is possible to view the state in which the outside area is present around the display 60. Subsequently, the glasses-type terminal 3 projects the light including information about the obtained projection image onto the optical member 32. As a result, it appears to the user that the transmission image of the display 60 and the reflected image of the outside area of the display image which could not be sufficiently displayed in the display 60 jointly constitute a single large screen.

Moreover, according to the first embodiment, through the optical member 32, the user becomes able to understand about the surroundings (i.e., the situation in the outside world). Therefore, the usage environment of the glasses-type terminal 3 is not limited to indoors, thereby making it possible to enhance the user-friendliness as compared to the conventional technology. Furthermore, according to the first embodiment, with respect to the display surface of the touch-sensitive panel 4 (can be considered to be the display surface of the display 60), the user can perform touch operations so as to, for example, move (scroll) the display image from side to side and up and down and change the image (the first image) displayed on the display 60, and can directly specify an arbitrary position in the display image. Thus, according to the first embodiment, it becomes possible to provide the glasses-type terminal 3 that has excellent safety and operability characteristics.

Moreover, according to the first embodiment, touch operations with respect to the display surface can be performed while looking at the transmission image of the display 60 through the optical member 32. Hence, the operations can be performed with less discomfort as compared to a conventional configuration in which touch operations with respect to a touch-sensitive panel are performed while looking through a video see-through type terminal at an image taken by a visible light camera by capturing a portable terminal having the touch-sensitive panel. As a result, it becomes possible to achieve further enhancement in the user operability as compared to the conventional technology. Furthermore, as described earlier, the glasses-type terminal 3 according to the first embodiment is configured as an optical see-through type terminal. Therefore, unlike the conventional technology, there is no need to capture the display 60 (the touch-sensitive panel 4) with a visible light camera. That is, the visible light camera is not a must. Thus, even if the situation is difficult for the use of a visible light camera (for example, at a public place), the use of the glasses-type terminal 3 is not restricted, thereby enabling achieving further enhancement in the user-friendliness.

### First Modification Example of First Embodiment

The first image and the second image need not always include equivalent information (information with equal level of detail). For example, when the display capability of the display 60 is higher as compared to the display capability of the reflected image seen through the optical member 32, an image having a greater volume of information (a higher level of detail) can be displayed in the display 60. For example, when contents representing a map are provided, an image of a map having a large volume of information (a high level of detail), such as a map having geographical names and addresses written in detail in small letters, can be displayed as the first image in the display 60. On the other hand, an image of a map having a small volume of information (a low level of detail), such as a map having only main geographical names written in large letters, can be projected as the second image. That enables the user to understand the overall perspective as well as the details at the same time. Meanwhile, maps are only exemplary, and any other contents can also be displayed.

Thus, based on the display image, the generator 22 can generate first images, which have a greater volume of information (a higher level of detail) as compared to second images, and second images.

### Second Modification Example of First Embodiment

In the first embodiment, an infrared camera is used as the second detector 31; and the positions, the size, and the deformation of the infrared LED markers 28 appearing in the image taken by the infrared camera is analyzed with the aim of detecting the relative position and orientation of the display 60 with respect to the glasses-type terminal 3. However, that is not the only possible case. Alternatively, for example, a camera (a depth sensor) that measures depth information and creates an image can be used as the second detector 31.

Still alternatively, for example, a visible light camera can also be used as the second detector 31. In that case, instead of disposing the infrared LED markers 28, predetermined fixed patterns are arranged around the display 60. When the display 60 is present within the field of view of the user, the visible light camera takes an image in which the fixed patterns arranged around the display 60 are captured. Then, the positions, the size, and the deformation of the fixed patterns appearing in the image can be analyzed with the aim of detecting the relative position and orientation of the display 60 with respect to the glasses-type terminal 3.

However, in the case of making use of a visible light camera, there may be a situation when it is difficult to actually use the camera in a public place due to privacy issues. Hence, it is desirable to use a sensor other than a visible light camera as the second detector 31. As a result of configuring the second detector 31 with a sensor other than a visible light camera, the glasses-type terminal 3 can be used even in a public place. That enables achieving further relaxation in the restrictions on the usage environment of the glasses-type terminal 3. Hence, the user-friendliness can be further enhanced. Moreover, for example, even if a visible light camera is installed, instead of outputting or storing the captured images without modification, the configuration can be such that only the information related to the relative positional relationship obtained from the captured images is output.

Moreover, for example, instead of using the infrared LED markers 28 or the fixed patterns, the feature quantity of the image taken by the second detector 31 can be used in detecting the relative position and orientation of the display 60 with respect to the glasses-type terminal 3.

### Third Modification Example of First Embodiment

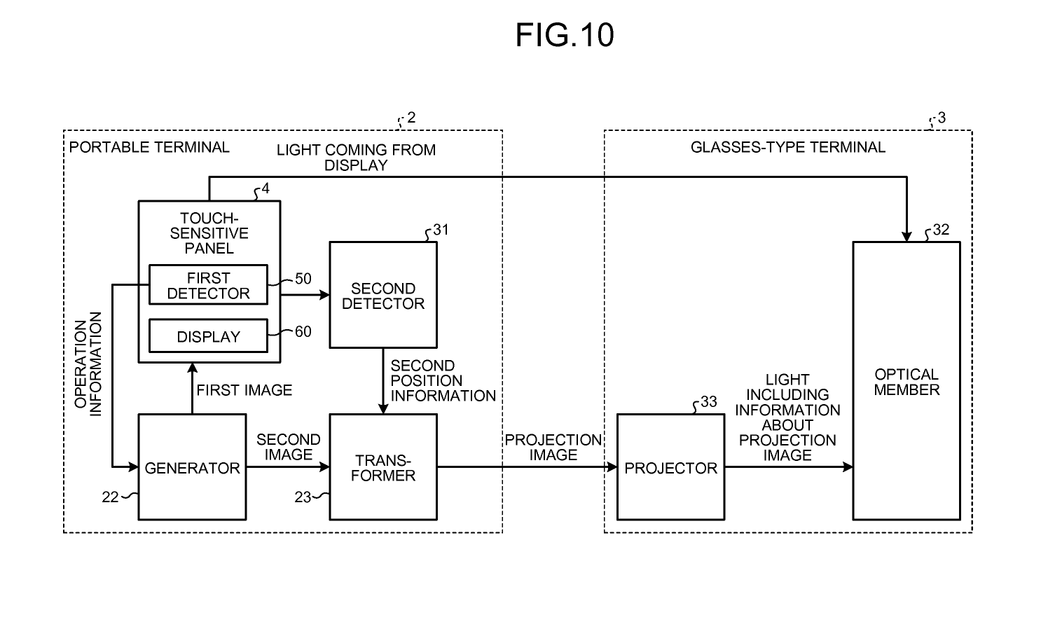

For example, as illustrated in FIG. 10, the second detector 31 can alternatively be installed in the portable terminal 2. In this example, the second detector 31 detects the relative position and orientation of the glasses-type terminal 3 with respect to the display 60, and generates second position information indicating the relative position and orientation of the glasses-type terminal 3 with respect to the display 60 (from a different perspective, the second position information can be considered to indicate the position of the display 60). Herein, the detection method is not limited to any particular method. Thus, a visible light camera embedded in the portable terminal 2 can be used to take an image of fixed patterns disposed in the glasses-type terminal 3, and the obtained image can be analyzed. Alternatively, an infrared camera embedded in the portable terminal 2 can be used to take an image of infrared light markers disposed in the glasses-type terminal 3, and the obtained image can be analyzed.

In an identical manner to the first embodiment, the transformer 23 generates a projection image by performing affine transformation on the second image, which is generated by the generator 22, based on the second position information, which is generated by the second detector 31, in such a way that, from the light that has come from the portable terminal 2 and has passed through the optical member 32 and from the light that includes the information about the projection image and that has reflected from the optical member 32, it is possible to view the state in which the outside area is present around the display 60. Then, the transformer 23 sends the projection image to the glasses-type terminal 3. Meanwhile, except for the fact that the second detector 31 is not installed, the configuration of the glasses-type terminal 3 is identical to the first embodiment.

### Fourth modification example of first embodiment

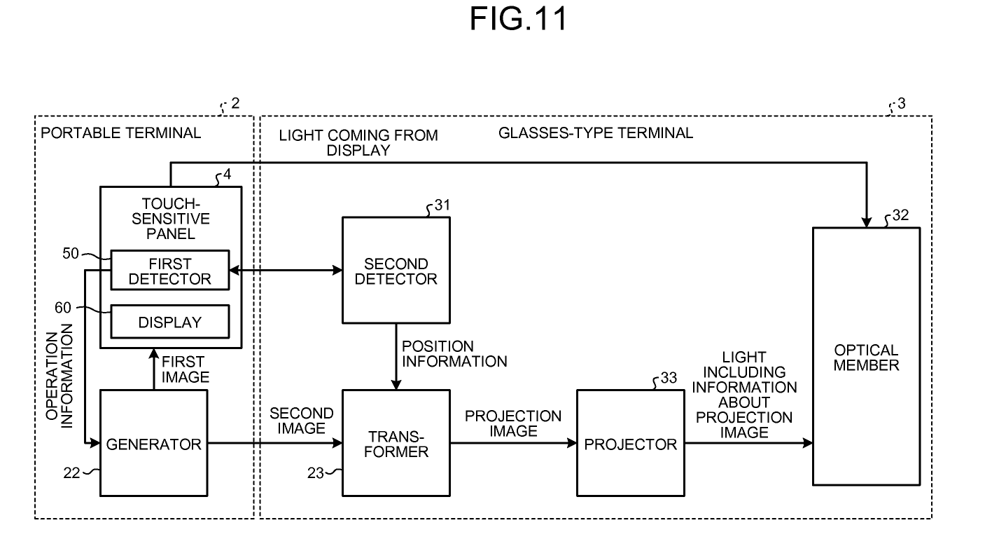

For example, as illustrated in FIG. 11, the transformer 23 can alternatively be installed in the glasses-type terminal 3. Aside from that, the configuration is identical to the first embodiment. In this example, the transformer 23 installed in the glassed-type terminal 3 can be considered to have the function corresponding to the “first obtainer” mentioned in claims.

### Fifth Modification Example of First Embodiment

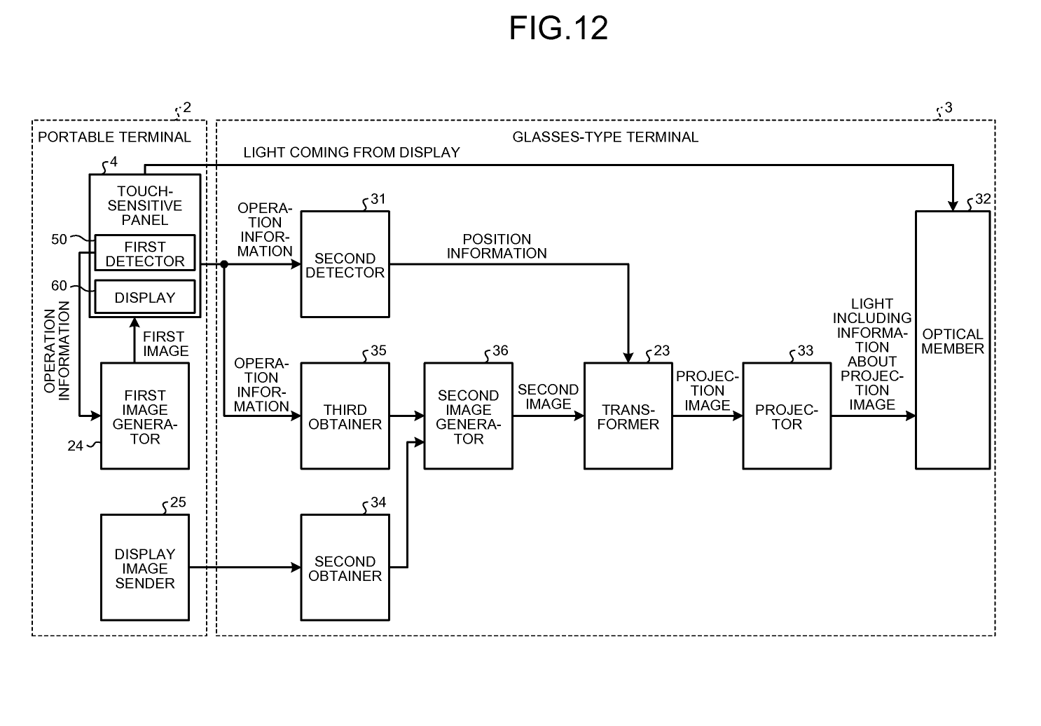

As another modification example of the fourth modification example, the function of generating first images can be implemented in the portable terminal 2, while the function of generating second images can be implemented in the glasses-type terminal 3. FIG. 12 is a block diagram illustrating an exemplary functional configuration of the portable terminal 2 and the glasses-type terminal 3 according to a fifth modification example. As illustrated in FIG. 12, the portable terminal 2 includes the touch-sensitive panel 4, a first image generator 24, and a display image sender 25. As compared to the first embodiment, the touch-sensitive panel 4 (the first detector 50) differs in the way that, upon detecting a touch operation, it sends operation information indicating the detected touch operation to the first image generator 24 and the glasses-type terminal 3.

The first image generator 24 generates a first image based on the operation information received from the touch-sensitive panel 4 (the first detector 50) and based on the display image; and sends the first image to the touch-sensitive panel 4 (the display 60). The display image sender 25 sends the display image to the glasses-type terminal 3.

Meanwhile, as compared to the configuration illustrated in FIG. 11, the configuration illustrated in FIG. 12 differs in the way that the glasses-type terminal 3 includes not only the second detector 31, the transformer 23, the optical member 32, and the projector 33 but also a second obtainer 34, a third obtainer 35, and a second image generator 36.

The second obtainer 34 has the function of obtaining the display image. In this example, the second obtainer 34 has the function of obtaining (receiving) the display image sent by the display image sender 25 of the portable terminal 2. However, that is not the only possible case. Alternatively, for example, the second obtainer 34 can be configured to obtain the display image directly from an external device. In that configuration, the display image sender 25 may be omitted.

The third obtainer 35 obtains the operation information from the touch-sensitive panel 4 (the first detector 50). The second image generator 36 generates a second image based on the display image obtained by the second obtainer 34 and the operation information obtained by the third obtainer 35. For example, when the touch operation specified in the operation information indicates scrolling of the display image from side to side and up and down with the aim of displaying, in the display 60, the portion that is not being sufficiently displayed in the display 60; then the second image generator 36 scrolls the display image according to the operation information and generates a second image by setting the luminance value (the pixel value) of the area corresponding to the image (i.e., the first image) in the display image that should be displayed in the display 60 to be equal to or smaller than a predetermined threshold value (in this example, the luminance value equivalent to “black”). Then, the second image generator 36 sends the second image to the transformer 23. Aside from that, the configuration is identical to the configuration illustrated in FIG. 11.

In the fifth modification example, the display image is transferred in advance from the portable terminal 2 to the glasses-type terminal 3. Thereafter, it is sufficient to only transfer the operation information, which indicates the touch operation detected by the first detector 50, to the glasses-type terminal 3. With that, it becomes possible to reduce the communication volume to a large extent as compared to the configuration in which, every time the first detector 50 detects a touch operation, the projection image generated according to the detected touch operation is transferred to the glasses-type terminal 3. As a result, it becomes possible to reduce, to a large extent, the occurrence of a case in which the timing at which the reflected image of the projection image is updated according to the touch operation is delayed as compared to the timing at which the transmission image of the display 60 is updated according to the touch operation.

Meanwhile, in this example too, the transformer 23 installed in the glasses-type terminal 3 can be considered to have the function corresponding to the “first obtainer” mentioned in claims.

### Sixth Modification Example of First Embodiment

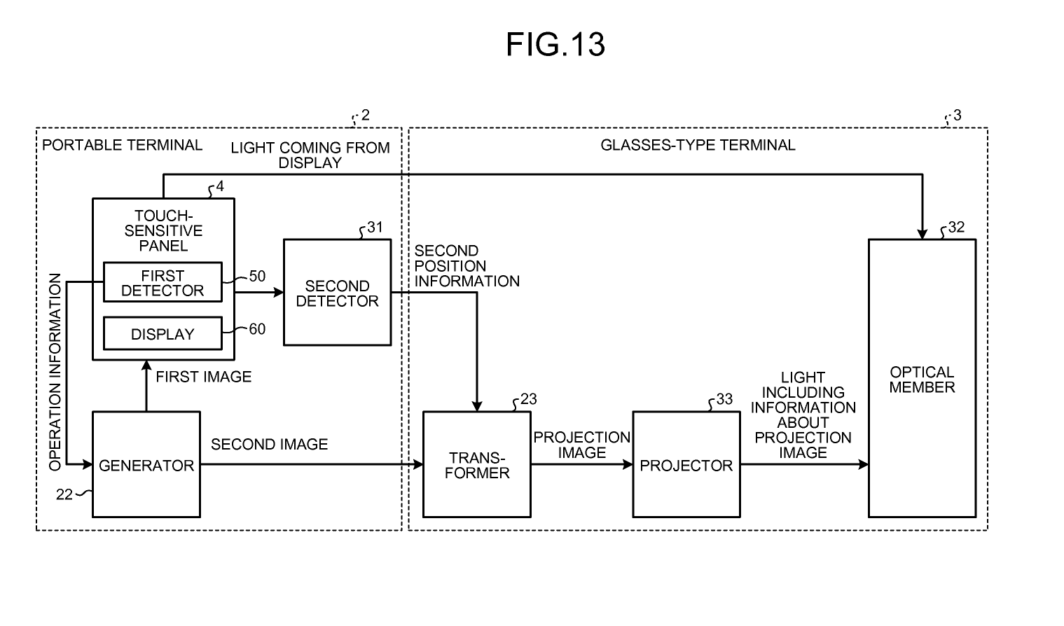

As still another modification example of the fourth modification example, for example, as illustrated in FIG. 13, the second detector 31 can alternatively be installed in the portable terminal 2. In a sixth modification example, the functions and operations of the second detector 31 are identical to the third modification example. Moreover, in the sixth modification example, the functions and operations of the transformer 23 are identical to the fourth modification example.

### Seventh Modification Example of First Embodiment

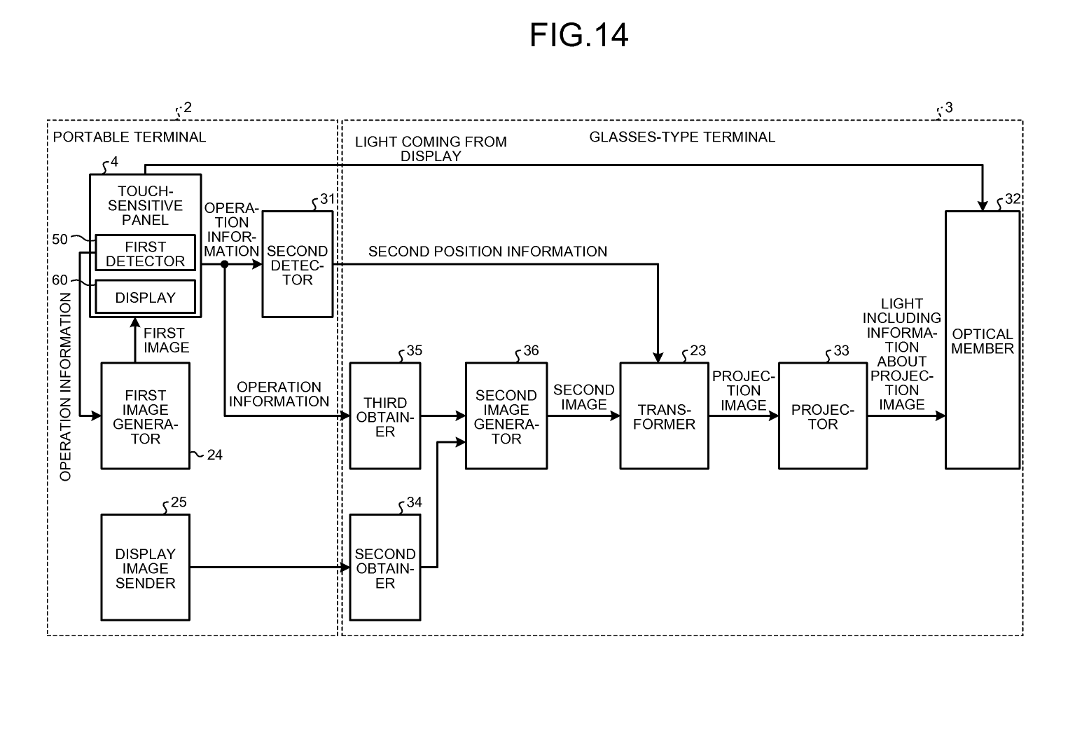

As another modification example of the fifth modification example, for example, as illustrated in FIG. 14, the second detector 31 can alternatively be installed in the portable terminal 2. In a seventh modification example, the functions and operations of the second detector 31 are identical to the third modification example. Aside from that, the configuration is identical to the fifth modification example.

### Second Embodiment

Given below is the explanation of a second embodiment. The image display system 1 according to the second embodiment further includes a determiner that, when the positional relationship between the glasses-type terminal 3 and the display 60 does not satisfy a specific standard, performs control not to project the projection image. The detailed explanation is given below. Meanwhile, regarding the common portion with the first embodiment, the explanation is appropriately skipped.

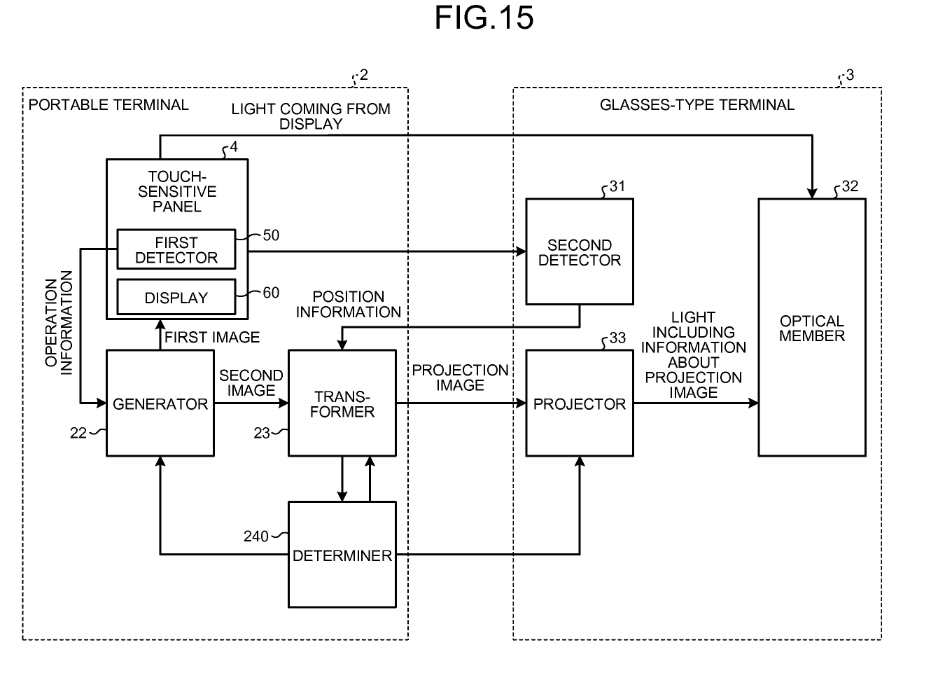

FIG. 15 is a diagram illustrating an exemplary functional configuration of the portable terminal 2 and the glasses-type terminal 3 according to the second embodiment. As illustrated in FIG. 15, the configuration differs from the first embodiment in the way that the portable terminal 2 further includes a determiner 240. When the amount of translation in the affine transformation matrix, which is used in affine transformation for generating a projection image, is smaller than a predetermined threshold value, the determiner 240 determines that the display 60 (the portable terminal 2) is present within the field of view, and determines that the specific standard is satisfied. On the other hand, when the amount of translation in the affine transformation matrix is equal to or greater than the predetermined threshold value, the determiner 240 determines that the display 60 is not present within the field of view, and determines that the specific standard is not satisfied.

Moreover, when the amount of rotation in the affine transformation matrix is smaller than a predetermined threshold value, the determiner 240 determines that the user and the display 60 are directly opposing each other (are completely facing each other), and determines that the specific standard is satisfied. On the other hand, when the amount of rotation in the affine transformation matrix is equal to or greater than the predetermined threshold value, the determiner 240 determines that the user and display 60 are not directly opposing each other (are not completely facing each other), and determines that the specific standard is not satisfied.

When the determiner 240 determines that the specific standard is satisfied, the portable terminal 2 and the glasses-type terminal 3 operate in an identical manner to the first embodiment. However, when the determiner 240 determines that the specific standard is not satisfied, the determiner 240 considers that the user is not looking at the display 60 and performs control not to project the projection image. For example, the determiner 240 can instruct the generator 22 to stop generating the second image and can instruct the transformer 23 to stop providing the second image. Alternatively, for example, the determiner 240 can perform control to stop the operations of the transformer 23 and the projector 33 of the glasses-type terminal 3. Still alternatively, for example, the determiner 240 can instruct the generator 22 to generates, as the second image, an image in which the luminance values of all areas of the display image is set to be equal to or smaller than a threshold value (in this example, the luminance value equivalent to “black”). In essence, the configuration can be such that, when the positional relationship between the glasses-type terminal 3 and the display 60 does not satisfy the specific standard, the determiner 240 performs control not to project the projection image.

In the second embodiment, the determiner 240 has the function of determining whether or not the positional relationship between the glasses-type terminal 3 and the display 60 satisfies the specific standard, as well as has the function of performing control not to project the projection image. However, alternatively, those functions can be implemented separately from (independently of) each other.

According to the second embodiment, when the portable terminal 2 is present within the field of view of the user and when the user is directly looking at the display 60 of the portable terminal 2, the reflected image of the outside area is presented to the user. Hence, for example, when the line of sight of the user is in some other direction than being toward the display 60, there is a decrease in the risk of carelessly blocking the field of view of the user due to the reflected image. That enables achieving enhancement in the safety of the user. Besides, the power consumption of the image display system 1 (particularly, the glasses-type terminal 3) can also be reduced.

### First Modification Example of Second Embodiment

For example, the determiner 240 receives, from the transformer 23, information indicating the relative position and orientation of the display 60 with respect to the glasses-type terminal 3 (can also be considered as information indicating the position of the display 60); and, based on the received information, calculates the angle made by a virtual straight line (a straight line set in advance) that represents the viewing direction of the user who is wearing the glasses-type terminal 3 and the normal line of the display 60. When the angle is smaller than a predetermined threshold value, the determiner 240 can determine that the user and the display 60 are completely facing each other, and can determine that the specific standard is satisfied. However, when the angle is equal to or greater than the predetermined threshold value, the determiner 240 can determine that the user and the display 60 are not completely facing each other, and can determine that the specific standard is not satisfied.

### Second Modification Example of Second Embodiment

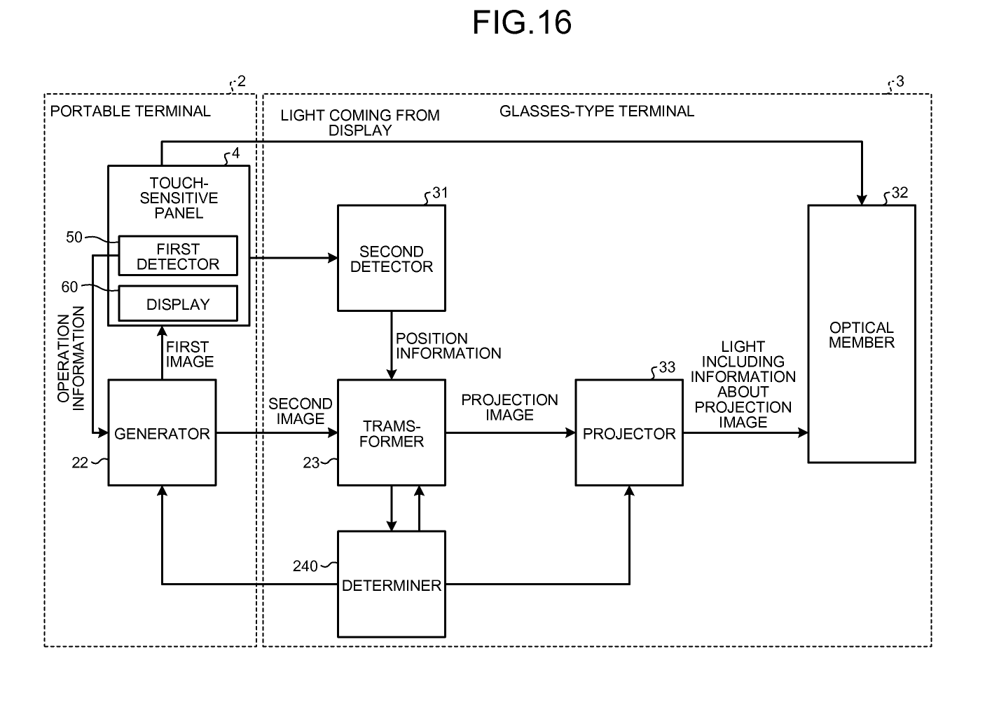

For example, the determiner 240 can alternatively be installed in the glasses-type terminal 3. For example, if the second embodiment is implemented with respect to the configuration illustrated in FIG. 11, a configuration illustrated in FIG. 16 can be achieved. In an identical manner, if the second embodiment is implemented with respect to the configurations according to other embodiments and modification examples, a configuration can be achieved in which the determiner 240 is installed in the glasses-type terminal 3. In essence, the glasses-type terminal 3 can be configured to include the determiner 240.

### Third Embodiment

Given below is the explanation of a third embodiment. As described earlier, in the second image, the area of the display image that corresponds to the first image is set to have the luminance value equal to or smaller than a predetermined threshold value. The image display system 1 according to the third embodiment further includes a boundary processor that, regarding the peripheral portion in the area of the second image that corresponds to the first image, sets the luminance value to be greater than the threshold value. The detailed explanation is given below. Meanwhile, regarding the common portion with the first embodiment, the explanation is appropriately skipped.

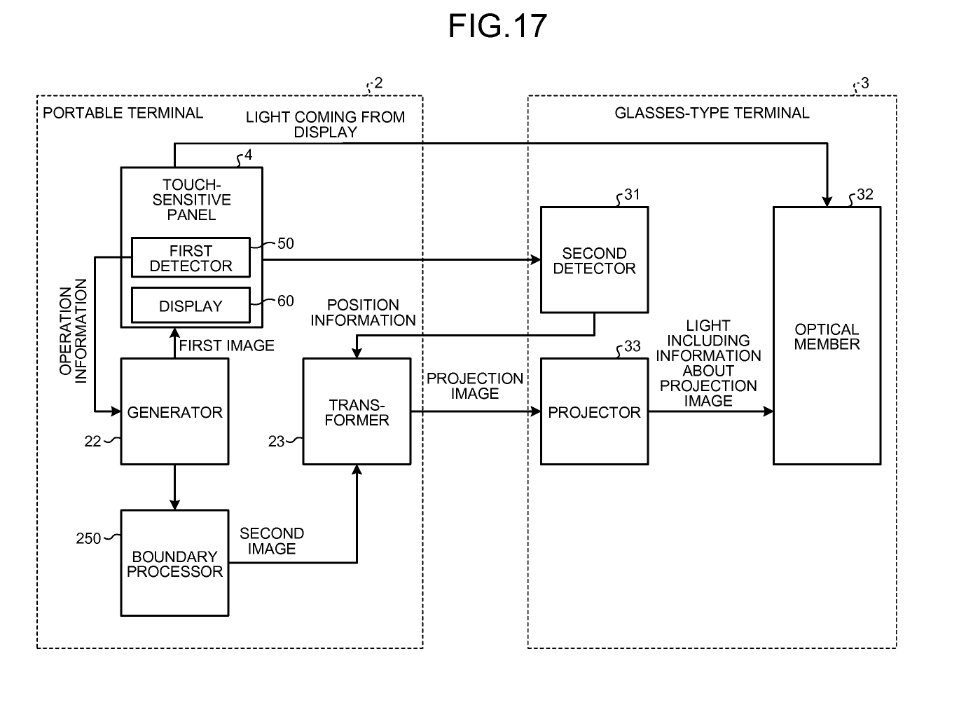

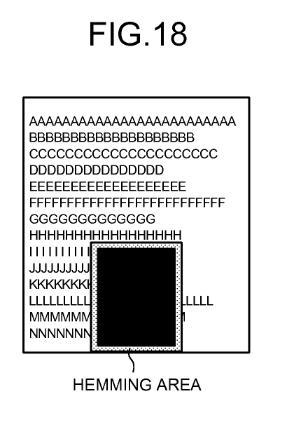

FIG. 17 is a diagram illustrating an exemplary functional configuration of the portable terminal 2 and the glasses-type terminal 3 according to the third embodiment. As illustrated in FIG. 17, the configuration differs from the first embodiment in the way that the portable terminal 2 further includes a boundary processor 250, which receives the second image generated by the generator 22 and adds a hemming area having an increased luminance value to the upper end, the lower end, the left end, and the right end of the area of the second image that corresponds to the first image (in this example, the blacked-out area in the second image). For example, to the second image illustrated in (c) in FIG. 3, the boundary processor 250 can add a hemming area having the luminance value equivalent to “gray” (an example of a higher luminance value than the threshold value indicating the luminance value equivalent to “black”) as illustrated in FIG. 18 (in FIG. 18, “gray” is displayed as a collection of dots). Then, the boundary processor 250 sends the second image having the hemming area added therein to the transformer 23. Aside from that, the details are identical to the first embodiment.

In this way, in the third embodiment, as a result of adding a hemming area to the second image, the boundary processor 250 can make the peripheral portion of the transmission image of the display 60 (the boundary portion of the reflected image) translucent before presenting the transmission image to the user. As a result, even if a detection error in the second detector 31 or a calculation error in the transformer 23 leads to a misalignment in the joint between the transmission image and the reflected image, it becomes possible to make it difficult for the user to visually recognize the misalignment.

### Modification Example of Third Embodiment

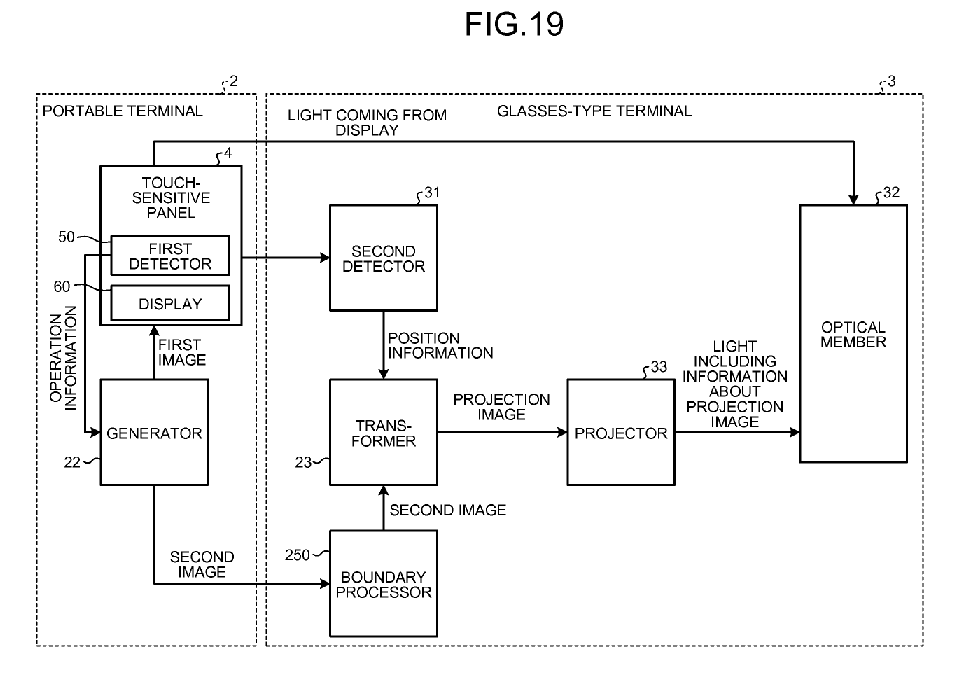

For example, the boundary processor 250 can alternatively be installed in the glasses-type terminal 3. For example, if the third embodiment is implemented with respect to the configuration illustrated in FIG. 11, a configuration illustrated in FIG. 19 can be achieved. In an identical manner, if the third embodiment is implemented with respect to the configurations according to other embodiments and modification examples, a configuration can be achieved in which the boundary processor 250 is installed in the glasses-type terminal 3. In essence, the glasses-type terminal 3 can be configured to include the boundary processor 250.

### Fourth Embodiment

Given below is the explanation of a fourth embodiment. The image display system 1 according to the fourth embodiment further includes a color controller that controls the luminance (brightness) of the light source of at least either the glasses-type terminal 3 or the portable terminal 2 or controls the gradation of at least either the first image or the second image in such a way that the appearance of the transmission image of the display 60 (i.e., the image quality indicating the appearance of the image) coincides with the appearance of the reflected image of the projection image. The detailed explanation is given below. Meanwhile, regarding the common portion with the first embodiment, the explanation is appropriately skipped.

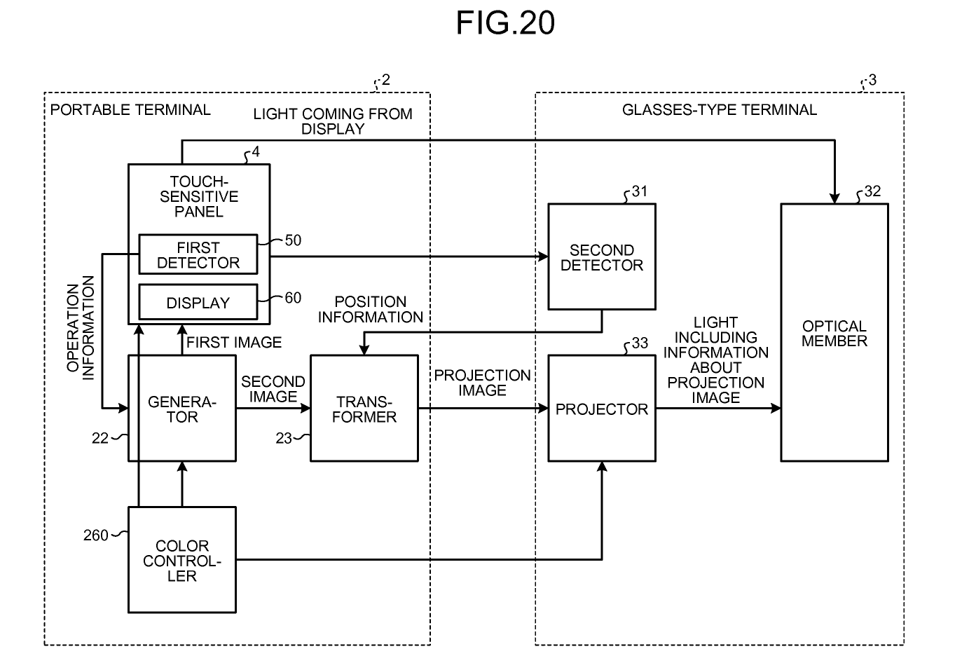

FIG. 20 is a diagram illustrating an exemplary functional configuration of the portable terminal 2 and the glasses-type terminal 3 according to the fourth embodiment. As illustrated in FIG. 20, the configuration differs from the first embodiment in the way that the portable terminal 2 further includes a color controller 260, which detects the luminance (brightness) of the surrounding environment and, based on the luminance, adjusts the luminance (brightness) of the light source of either the display 60 or the projector 33 (for example, in a liquid crystal display, the backlight serves as the light source; and in an organic EL display, the display panel itself can be considered to be the light source); and can bring the luminance of the transmission image and the luminance of the reflected image closer to each other. Alternatively, in order to conform the color shade of the transmission image of the display 60 to the color shade of the reflected image of the projection image, the color controller 260 can instruct the generator 22 to adjust the gradation of the first image or the gradation of the second image. Still alternatively, in order to conform the color shade and the luminance of the transmission image of the display 60 to the color shade and the luminance of the reflected image of the projection image, the color controller 260 can instruct the generator 22 to adjust the luminance of the light source of the display 60 or the luminance of the light source of the projector 33 as well as to adjust the gradation of the first image or the gradation of the second image based on the luminance of the surrounding environment.

In essence, the configuration can be such that the color controller 260 controls the light source of at least either the first image or the second image or controls the gradation of at least either the first image or the second image so as to coincide with the appearance of the transmission image of the display 60 with the appearance of the reflected image of the projection image. According to the fourth embodiment, it becomes possible to reduce the discrepancy between the appearance of the transmission image and the appearance of the reflected image. Hence, to the user who is wearing the glasses-type terminal 3, a screen can be presented in which the transmission image and the reflected image are joined in a more natural way.

However, that is not the only possible configuration. Alternatively, for example, the configuration can be such that the appearance of the transmission image of the display 60 is set to be different than the appearance of the reflected image of the projection image. For example, the configuration can be such that, with the aim of saving electrical power in the glasses-type terminal 3, an image formed by inverting the gradation of each of a plurality of pixels constituting the second image (by performing, what is called, negative-positive transformation) is projected as the projection image.

### Modification Example of Fourth Embodiment

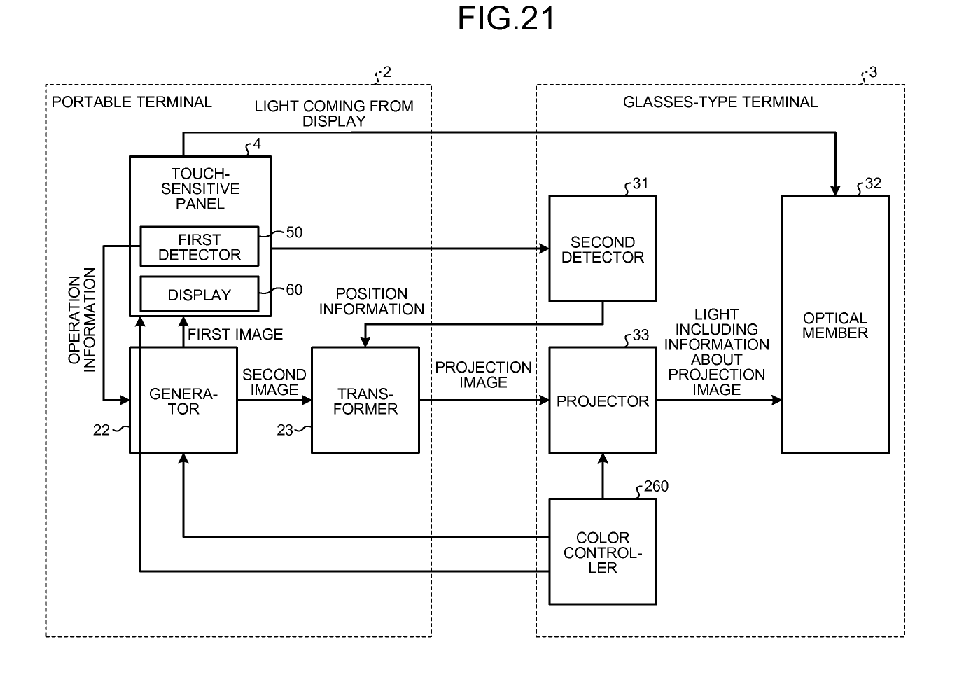

For example, the color controller 260 can alternatively be installed in the glasses-type terminal 3. For example, if the fourth embodiment is implemented with respect to the configuration illustrated in FIG. 2, a configuration illustrated in FIG. 21 can be achieved. In an identical manner, if the fourth embodiment is implemented with respect to the configurations according to other embodiments and modification examples, a configuration can be achieved in which the color controller 260 is installed in the glasses-type terminal 3. In essence, the glasses-type terminal 3 can be configured to include the color controller 260.

### Fifth Embodiment

Given below is the explanation of a fifth embodiment. The image display system 1 according to the fifth embodiment further includes an updating controller that controls the timing of updating the first image or the timing of updating the second image in such a way that the timing of updating the transmission image of the display 60 according to the touch operation coincides with the timing of updating the reflected image according to the touch operation. The detailed explanation is given below. Meanwhile, regarding the common portion with the first embodiment, the explanation is appropriately skipped.

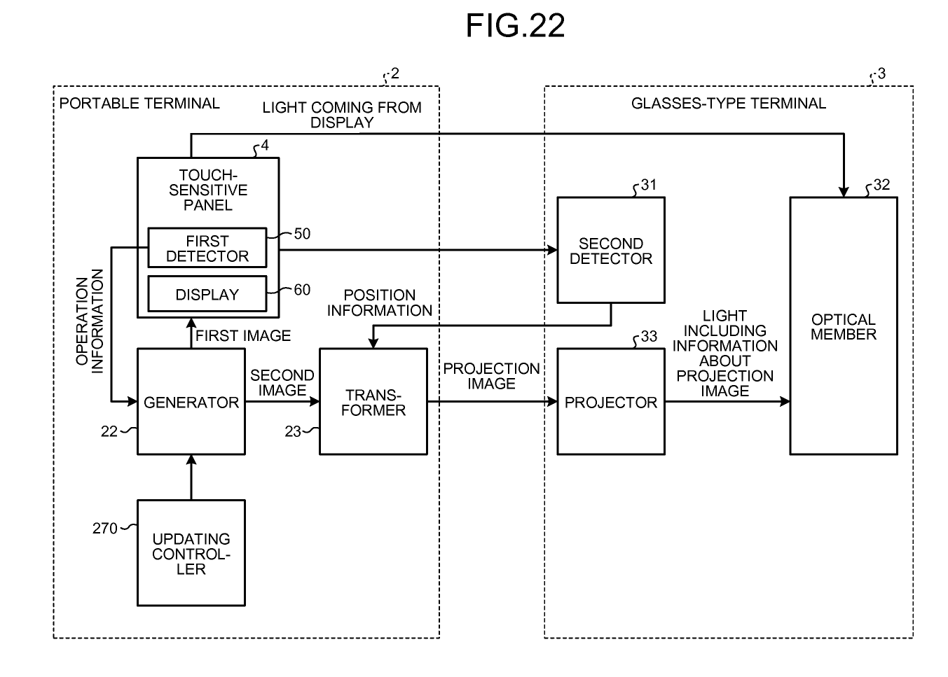

FIG. 22 is a diagram illustrating an exemplary functional configuration of the portable terminal 2 and the glasses-type terminal 3 according to the fifth embodiment. As illustrated in FIG. 22, the configuration differs from the first embodiment in the way that the portable terminal 2 further includes an updating controller 270, which instructs the generator 22 to shift the timing of updating the first image according to the touch operation from the timing of updating the second image according to the touch operation. For example, in the case in which, due to a delay in image communication (transfer of the projection image) from the portable terminal 2 to the glasses-type terminal 3, the timing of updating the projection image gets delayed as compared to the timing of updating the transmission image of the display 60; the updating controller 270 instructs the generator 22 to delay the timing of the first image. Alternatively, the updating controller 270 can instruct the generator 22 to estimate, using a Kalman filter, the next movement of the user from time-series data of the touch operation detected by the first detector 50 and, according to the estimation result, advance the timing of updating the second image.

In essence, the configuration can be such that the timing of updating the first image or the timing of updating the second image is controlled to ensure that the timing of updating the transmission image of the display 60 according to the touch operation coincides with the timing of updating the reflected image of the projection image according to the touch operation. Thus, according to the fifth embodiment, it becomes possible to reduce the discrepancy between the timing of updating the transmission image according to the touch operation and the timing of updating the reflected image according to the touch operation. Hence, it becomes possible to make it difficult for the user to visually recognize the joint between the transmission image and the reflected image.

### Modification Example of Fifth Embodiment

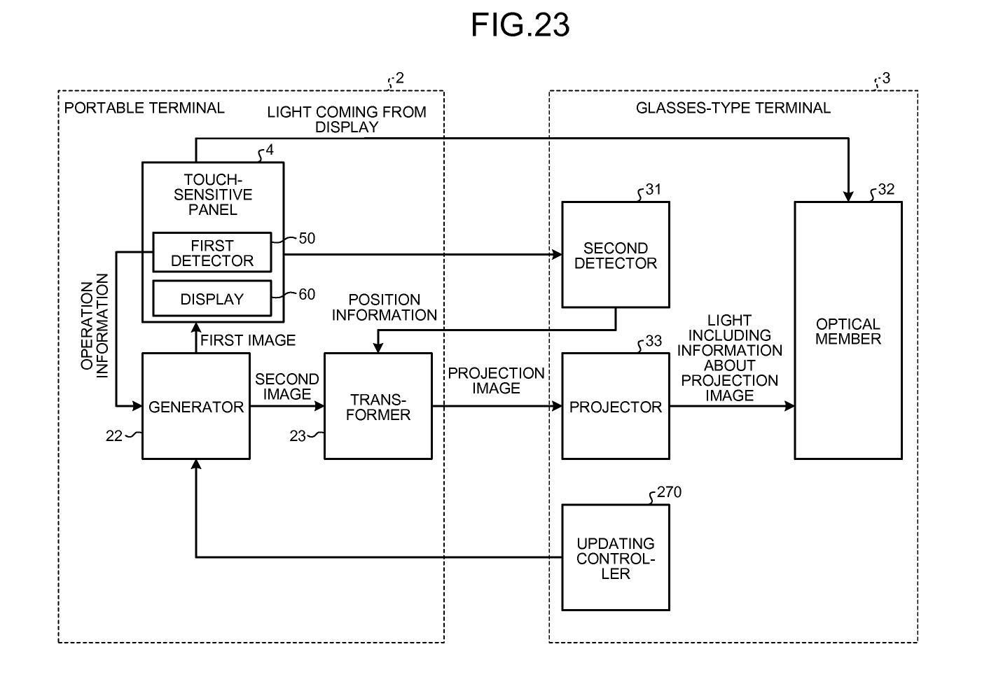

For example, the updating controller 270 can alternatively be installed in the glasses-type terminal 3. For example, if the fifth embodiment is implemented with respect to the configuration illustrated in FIG. 2, a configuration illustrated in FIG. 23 can be achieved. In an identical manner, if the fifth embodiment is implemented with respect to the configurations according to other embodiments and modification examples, a configuration can be achieved in which the updating controller 270 is installed in the glasses-type terminal 3. In essence, the glasses-type terminal 3 can be configured to include the updating controller 270.

Moreover, the embodiments and the modification examples described above can be combined in an arbitrary manner.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a projector to project light including information about a projection image;
an optical member to transmit light coming from an information processing device but reflect the light including the information about the projection image incident thereon, the information processing device including a first detector capable of detecting a touch operation onto a display screen and a display that displays a first image representing at least a part of a display image; and
a first obtainer to obtain the projection image formed by performing transformation on a second image, which includes a non-overlapping area of the display image representing an area not overlapping with at least a part of the first image, based on position of the display in such a way that, from light that has come from the information processing device and has passed through the optical member and from the light including the information about the projection image that has reflected from the optical member, a state in which the non-overlapping area is present around the display is viewable.

2. The device according to claim 1, wherein the non-overlapping area of the display image represents an area on outside of the first image.

3. The device according to claim 1, further comprising a determiner to, when a positional relationship between the display device and the display does not satisfy a specific standard, perform control not to project the projection image.

4. The device according to claim 3, wherein
the transformation is affine transformation, and
when amount of translation in an affine transformation matrix, which is used in the affine transformation, is equal to or greater than a predetermined threshold value, the determiner determines that the specific standard is not satisfied.

5. The device according to claim 3, wherein
the transformation is affine transformation, and
when amount of rotation in an affine transformation matrix, which is used in the affine transformation, is equal to or greater than a predetermined threshold value, the determiner determines that the specific standard is not satisfied.

6. The device according to claim 3, wherein, based on position of the display, the determiner obtains angle defined by a virtual straight line representing viewing direction of a user and normal line of the display and, when the angle is equal to or greater than a threshold value, determines that the specific standard is not satisfied.

7. The device according to claim 2, wherein
the second image represents an image in which an area of the display image that corresponds to the first image is set to have luminance value equal to or smaller than a predetermined threshold value, and
the display device further comprises a boundary processor to set luminance value of peripheral portion in the area of the second image that corresponds to the first image to a value greater than the threshold value.

8. The device according to claim 1, further comprising a color controller to control luminance of a light source of at least one of the display device and the information processing device or control gradation of at least one of the first image and the second image, in such a way that appearance of a transmission image of the display coincides with appearance of a reflected image of the projection image.

9. The device according to claim 1, further comprising an updating controller to control timing of updating the first image or timing of updating the second image in such a way that timing of updating a transmission image of the display in response to the touch operation coincides with timing of updating a reflected image of the projection image in response to the touch operation.

10. The device according to claim 1, further comprising a second detector to detect position of the display, wherein
the detector is configured with a sensor other than a visible light camera.

11. The device according to claim 1, further comprising:
a second obtainer to obtain the display image;
a third obtainer to obtain operation information which indicates the touch operation detected by the first detector; and
a second image generator to generate the second image based on the display image and the operation information, wherein
the first obtainer generates the projection image by performing the transformation on the second image.

12. The device according to claim 1, wherein the first image has a greater volume of information than the second image.

13. An image display system comprising:
an information processing device that includes
a detector capable of detecting a touch operation onto a display screen, and
a display to display a first image representing at least a part of a display image;
a display device;
a projector to project light including information about a projection image;
an optical member to transmit light coming from the information processing device but reflect the light including the information about the projection image incident thereon; and
a transformer to generate the projection image by performing transformation on a second image, which includes a non-overlapping area of the display image representing an area not overlapping with at least a part of the first image, based on position of the display in such a way that, from light that has come from the information processing device and has passed through the optical member and from the light including the information about the projection image that has reflected from the optical member, a state in which the non-overlapping area is present around the display is viewable.

14. An information processing method comprising:
detecting a touch operation onto a display screen;
obtaining position of a display that displays a first image, which represents at least a part of a display image, in response to the detected touch operation;
generating the projection image by performing transformation on a second image, which includes a non-overlapping area of the display image representing an area not overlapping with at least a part of the first image, based on position of the display in such a way that, from light that has come from an information processing device and has passed through an optical member, which transmits light coming from the information processing device including the display but which reflects light including information about a projection image, and from the light including information about the projection image and that has reflected from the optical member, a state in which the non-overlapping area is present around the display is viewable; and
performing control to project the projection image on a display device that includes the optical member.
